(19) United States
(12) Patent Application Publication
(10) Pub. No.: US 2024/0421537 A1
(43) Pub. Date: Dec. 19, 2024

(54) LOCKABLE CONNECTOR ASSEMBLY

(71) Applicant: P-TWO INDUSTRIES INC., Taoyuan City (TW)

(72) Inventors: Hsien-Chang LIN, Taoyuan City (TW); Chun-Wei CHANG, Taoyuan City (TW)

(21) Appl. No.: 18/414,987

(22) Filed: Jan. 17, 2024

(30) Foreign Application Priority Data
Jun. 15, 2023 (TW) 112206127

(51) Int. Cl. H01R 13/627

(52) U.S. Cl. CPC H01R 13/6275

(57) ABSTRACT

The present invention relates to a lockable connector assembly, including a wire-end connector and a board-end connector. The wire-end connector includes a first body and a locking member. The first body has a flexible positioning member and a side guide groove. The locking member is movably disposed in the side guide groove. When the locking member is located in an initial position, the wire-end connector is capable of being engaged with the board-end connector. When the locking member is moved from the initial position to an insertion position, the locking member is abutted against the flexible positioning member so that the flexible positioning member is fixedly disposed in the locked position.

### CROSS-REFERENCES TO RELATED APPLICATIONS

This application claims the benefit of priority to Taiwanese Patent Application No. 112206127 filed on Jun. 15, 2023, which is hereby incorporated by reference in its entirety.

### BACKGROUND OF THE INVENTION

### Field of the Invention

The present invention relates to a connector assembly, in particular a lockable connector assembly after being engaged.

### Descriptions of the Related Art

Electrical connectors are widely used in the transmission of power or signals, e.g., connection between wires and circuit boards, or connection between two circuit boards in a system. In various fields, electrical connectors have become indispensable important components.

Especially in recent years, with the booming development of electric vehicles and automotive electronics, environmental conditions, such as vibration, humidity, and high temperature, have to be considered for the application environment of automotive electrical connectors. To ensure the normal operation of various systems in the vehicle, the structure of automotive electrical connectors and the operation method should have high reliability and high stability. The structure of the automotive electrical connectors should be capable of preventing unintentional disengagement when the system is in operation. The user should be prevented from engaging or disengaging the connectors incorrectly. As a result, it is well known that a connector position assurance (CPA) functions as a locking mechanism to ensure that the electrical connectors are locked in the correct position, and misoperation or unintentional disengagement of the connectors can be prevented.

However, different types of electrical connectors have different structures and connection methods, and their corresponding connector position fixing structures also differ in structural configuration and operation methods. As a result, there is still room for improvement.

### SUMMARY OF THE INVENTION

The objective of the present invention is to provide a lockable connector assembly for electrical connection between a circuit board and wires. The connector assembly includes a board-end connector and a wire-end connector which can be engaged with each other. Disengagement of the wired-end connector from the board-end connector can be prevented by operating a locking structure after engagement of the wire-end connector with the board-end connector so as to ensure the reliability and stability of the connection between the connectors. In addition, the locking structure of the present invention also has a foolproof design for enabling the user to engage the connectors with each other and then lock the connectors in a correct manner.

To achieve the above objective, the present invention discloses a lockable connector assembly including a wire-end connector, a plurality of wires, a board-end connector and a plurality of contacts. The wire-end connector includes a first body and a locking member. The first body has a flexible positioning member and a side guide groove. The locking member is movably disposed in the side guide groove and is movable between an initial position where the locking member is distal from the flexible positioning member and an insertion position where the locking member is abutted against the flexible positioning member. One end of each wire is disposed in the first body. The board-end connector includes a second body with an accommodating space for reception of the first body. The contacts are partially extended and disposed in the second body. When the locking member is located in the initial position, the wire-end connector is capable of being engaged with the board-end connector so that the first body is partially disposed in the accommodating space and that the flexible positioning member is located in a locked position of the accommodating space, and the contacts are electrically connected to the wires. When the locking member is moved from the initial position to the insertion position, the locking member is abutted against the flexible positioning member so that the flexible positioning member is retained in the locked position.

The flexible positioning member has a pair of first elastic arms. An insertion space is formed between the pair of first elastic arms. The locking member has an extension part. When the locking member is moved to the insertion position, the extension part is inserted into the insertion space to restrict the pair of first elastic arms.

The accommodating space includes a side connection region for accommodating the flexible positioning member. Each of the pair of first elastic arms has a first protruding part. The second body has two second protruding parts formed on the side connection region and facing each other. A gap between the second protruding parts is smaller than an outer dimension defined by the first protruding parts of the pair of first elastic arms under a normal condition. When the wire-end connector is engaged with the board-end connector, the first protruding parts and the second protruding parts interfere with each other so that the pair of first elastic arms are deformed.

The locking member further has a pair of second elastic arms. The pair of second elastic arms and the extension part are disposed in the side guide groove, and the extension part is located between the pair of second elastic arms.

When the wire-end connector is engaged with the board-end connector and the locking member is located in the insertion position, the extension part partially extends to the side connection region and is inserted into the insertion space.

The locking member further has a pair of positioning bumps respectively formed on the pair of second elastic arms. The wire-end connector further has a first positioning hole and a second positioning hole formed in the side guide groove. When the locking member is located in the initial position, the positioning bump is engaged with the first positioning hole. When the locking member is located in the insertion position, the positioning bump is engaged with the second positioning hole.

The wire-end connector further has a stop part adjacent to the first positioning hole.

The locking member further has an operating part outside the side guide groove.

The board-end connector is disposed on a circuit board. One end of each contact is electrically connected to the circuit board, and the other end of each contact extends into the second body of the accommodating space.

The wire-end connector further includes a locking structure for retaining the wires.

When the locking member is located in the insertion position, the flexible positioning member is prevented from entering the side connection region by interference between the first protruding parts and the second protruding parts.

By referring to the drawings and the detailed description of embodiments described later, those of ordinary skill in the art can understand other objectives of the present invention, as well as the technical means and implementations of the present invention.

### BRIEF DESCRIPTION OF THE DRAWINGS

FIG. 1 is a perspective view schematically showing the connector assembly of the present invention;

FIG. 2 is a perspective view schematically showing the connector assembly of the present invention in a locked state;

FIG. 3 is an exploded view of the wire-end connector;

FIG. 4 is a partially sectional perspective view schematically showing the wire-end connector;

FIG. 5 is a schematic sectional side view of the connector assembly of the present invention before the wire-end connector is engaged with a board-end connector;

FIG. 6 is a schematic sectional side view of the connector assembly of the present invention when the wire-end connector is engaged with the board-end connector;

FIG. 7 is another partially sectional perspective view schematically showing the wire-end connector;

FIG. 8 is a schematic sectional side view of the connector assembly of the present invention after the connectors are engaged with each other and locked; and

FIG. 9 is a schematic sectional side view showing that the connector assembly of the present invention is incorrectly operated.

### DETAILED DESCRIPTION OF THE PREFERRED EMBODIMENT

In the following description, the present invention will be explained with reference to various embodiments thereof. These embodiments of the present invention are not intended to limit the present invention to any specific environment, application or particular method for implementations described in these embodiments. Therefore, the description of these embodiments is for illustrative purposes only and is not intended to limit the present invention. It shall be appreciated that, in the following embodiments and the attached drawings, a part of elements not directly related to the present invention may be omitted from the illustration, and dimensional proportions among individual elements and the numbers of each element in the accompanying drawings are provided only for ease of understanding but not to limit the present invention.

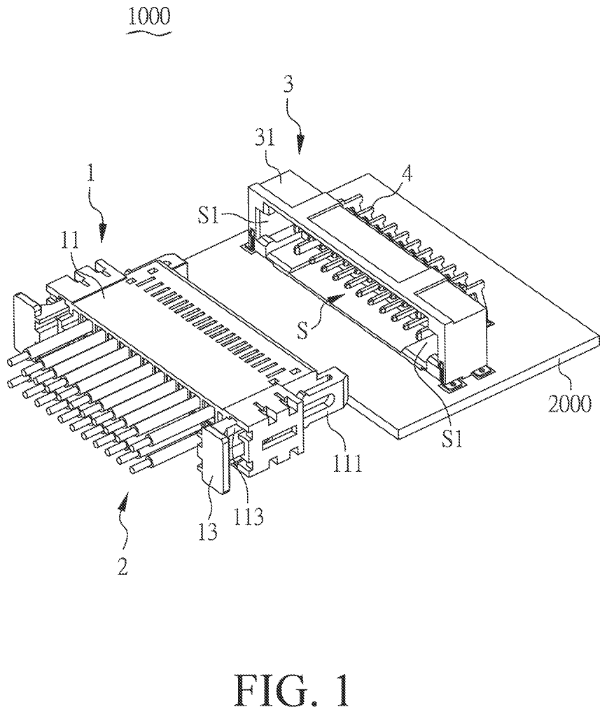

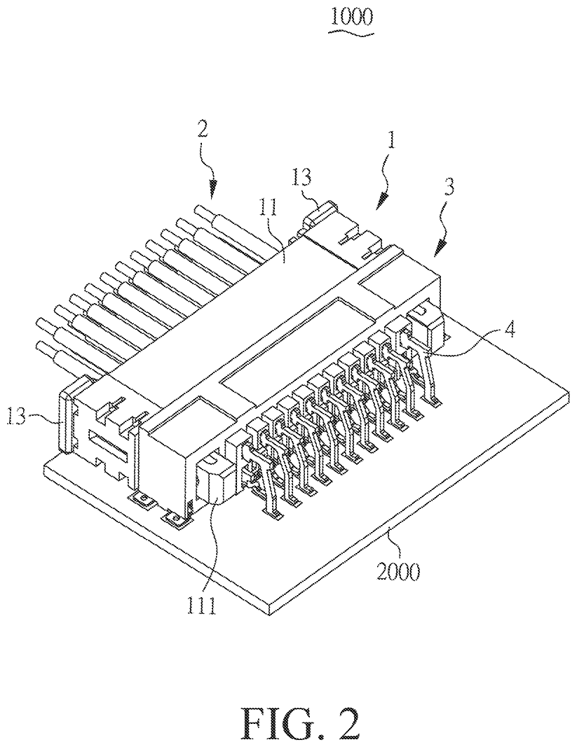

Reference is made to FIG. 1 and FIG. 2. FIG. 1 a perspective exploded view schematically showing the connector assembly of the present invention before engagement. FIG. 2 is a perspective view schematically showing the connector assembly of the present invention in a locked state. The connector assembly 1000 of the present invention includes a wire-end connector 1, a plurality of wires 2, a board-end connector 3 and a plurality of terminals 4. The board-end connector 3 is disposed on a circuit board 2000, and the wire-end connector 1 is to be engaged with the board-end connector 3 and then locked. The structure and operation methods will be explained in detail below.

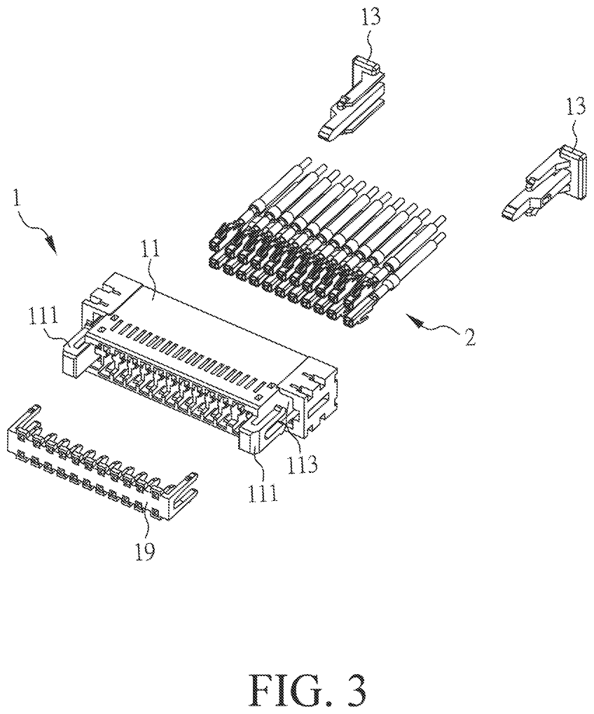

The wire-end connector 1 will be described first with reference to FIG. 3, which is an exploded view showing the wire-end connector 1. The wire-end connector 1 includes a first body 11 and two locking members 13 disposed on two sides of the first body 11. The first body 11 has flexible positioning members 111 and side guide grooves 113 disposed on the two sides of the first body 11. The locking member 13 is movably disposed in the side guide groove 113, and the locking member 13 can be moved between an initial position (as shown in FIG. 1) and an insertion position (as shown in FIG. 2), which will be described in detail later.

One end of each of the wires 2 is disposed in the first body 11. In this embodiment, the wires 2 are in arranged in two rows, but the present invention is not limited hereto. Preferably, in this embodiment, the wire-end connector 1 may further include a locking structure 19 (also referred to as a terminal position positioning assurance (TPA)). When the wires 2 are inserted into the wire-end connector 1, the locking structure 19 can serve as a locking mechanism for retaining the wires 2 in the correct position in the wire-end connector 1 and for preventing the wires 2 from being detached from the wire-end connector 1.

As shown in FIG. 1 and FIG. 2, the board-end connector 3 includes a second body 31, and the second body 31 has an accommodating space S for reception of the first body 11. The contacts 4 are partially extended and arranged in the second body 31. More specifically, one end of each of the contacts 4 is electrically connected to the circuit board 2000, and the other end of each of the contacts 4 extends into the accommodating space S of the second body 31.

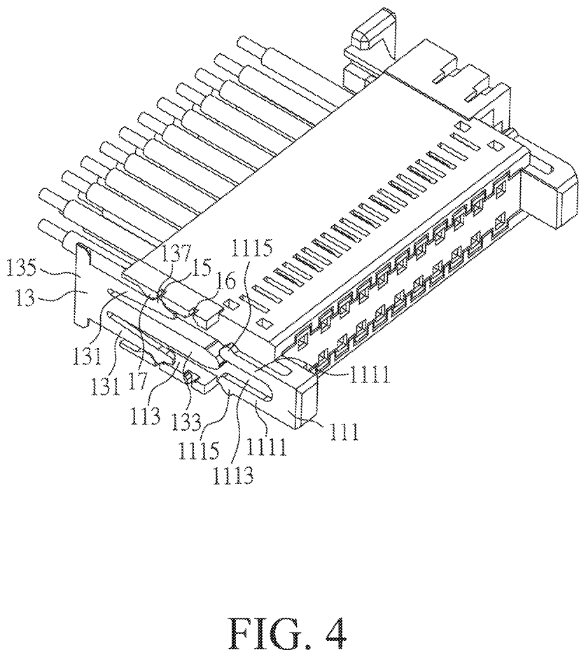

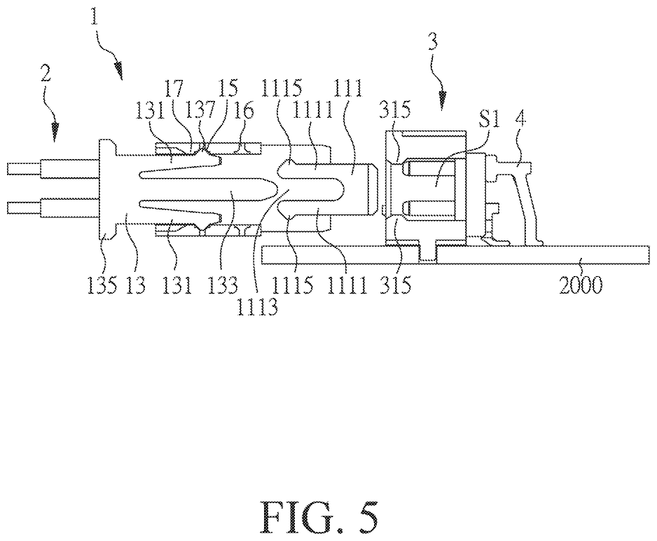

Reference is then made to FIG. 4 and FIG. 5, which illustrate the state of the wire-end connector 1 and the board-end connector 3 before being engaged with each other. FIG. 4 is a partially sectional perspective view schematically showing the wire-end connector 1 when the locking member 13 is located in the initial position, and FIG. 5 is a schematic sectional side view showing a state before the wire-end connector 1 and the board-end connector 3 are engaged with each other. As shown, the locking member 13 is distal from the flexible positioning member 111 when located in the initial position. The flexible positioning member 111 has a pair of first elastic arms 1111. An insertion space 1113 is formed between the pair of first elastic arms 1111. The locking member 13 has a pair of second elastic arms 131, an extension part 133, an operating part 135 and a pair of positioning bumps 137. The extension part 133 is located between the pair of second elastic arms 131. The second elastic arms 131 and the extension part 133 are disposed in the side guide groove 113. The operating portion 135 is located outside the side guide groove 113. In addition, the positioning bumps 137 are formed on the pair of second elastic arms 131, respectively. The wire-end connector 1 further includes a first positioning hole 15, a second positioning hole 16 and a stop part 17 formed in the side guide groove 113. When the locking member 13 is located in the initial position, the positioning bump 137 is engaged with the first positioning hole 15, and the stop part 17 is adjacent to the first positioning hole 15 for preventing the locking member 13 from being detached from the side guide groove 113. When the locking member 13 is located in the insertion position, the positioning bump 137 is engaged with the second positioning hole 16.

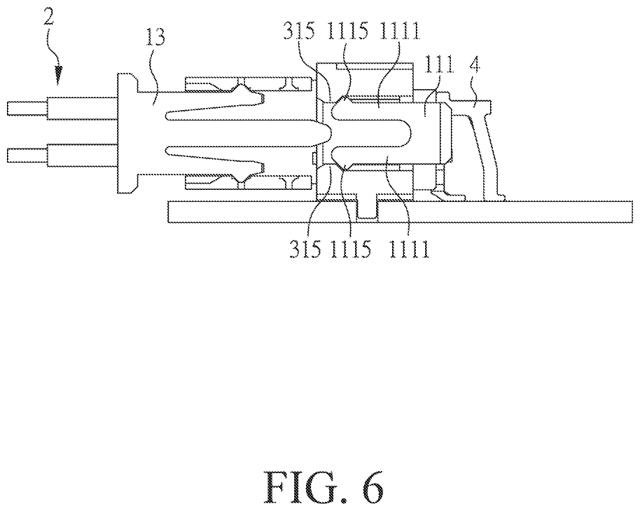

Next, the state in which the wire-end connector 1 and the board-end connector 3 are being engaged with each other will be described. Reference is made to FIG. 1, FIG. 5 and FIG. 6. The accommodating space S includes side connection regions S1 located on both sides. When the locking member 13 is in the initial position (as shown in FIG. 5), the wire-end connector 1 is allowed to be engaged with the board-end connector 3. Specifically, each of the pair of first elastic arms 1111 has a first protruding part 1115. The second body 31 has two second protruding parts 315. The second protruding parts 315 are formed in the side connection region S1 and face each other, as shown in FIG. 5 and FIG. 6. The gap between the second protruding parts 315 is smaller than the outer dimension defined by the first protruding parts 1115 of the pair of first elastic arms 1111 under a normal condition. During the process in which the wire-end connector 1 and the board-end connector 3 are being engaged with each other, the first protruding parts 1115 and the second protruding parts 315 will first interfere with each other. Since the pair of first elastic arms 1111 has elasticity, the first protruding parts 1115 can be abutted against the second protruding parts 315 first, and the pair of first elastic arms 1111 are deformed accordingly so that the flexible positioning member 111 can pass through the gap between the second protruding parts 315 and then the flexible positioning member 111 is accommodated in the side connection region S1, as shown in FIG. 6. At the same time, the first body 11 is partially disposed in the accommodating space S (as shown in FIG. 2), the flexible positioning member 111 is located in a locked position of the side connection region S1 of the accommodating space S, and the contacts 4 can be electrically connected to the wires 2.

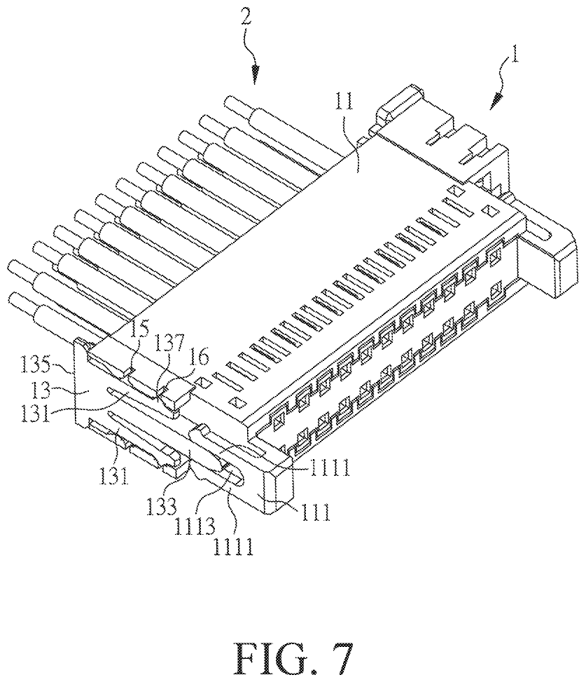

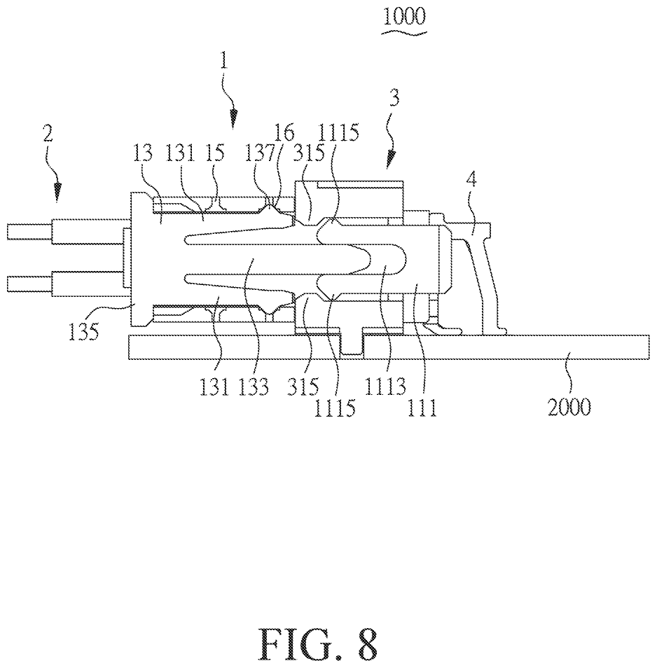

Next, the process of further locking operation will be described. Reference is made to FIG. 7 and FIG. 8. When the flexible positioning member 111 is located in the locked position of the side connection region S1 in the accommodating space S, the user can further press the operating part 135 outside the side guide groove 113 so as to move the locking member 13 from the initial position to the insertion position. At this time, the positioning bumps 137 are engaged with the second positioning holes 16, as shown in FIG. 7 and FIG. 8.

When the locking member 13 is moved from the initial position to the insertion position, the locking member 13 is abutted against the flexible positioning member 111 to retain the flexible positioning member 111 in the locked position. Specifically, when the locking member 13 is moved to the insertion position, a portion (i.e., the front portion) of the extension part 133 extends into the side connection region S1 and is inserted into the insertion space 1113. Since the insertion space 1113 has been filled with the extension part 133, there is insufficient space for allowing deformation of the pair of first elastic arms 1111 so that the pair of first elastic arms 1111 can be restricted. Furthermore, the outer dimension defined by the first protruding parts 1115 is larger than the gap between the second protruding parts 315, and deformation of the first elastic arms 1111 is not allowed. As a result, it can be ensured that the flexible positioning member 111 is retained in the locked position and cannot be detached from the insertion space 1113.

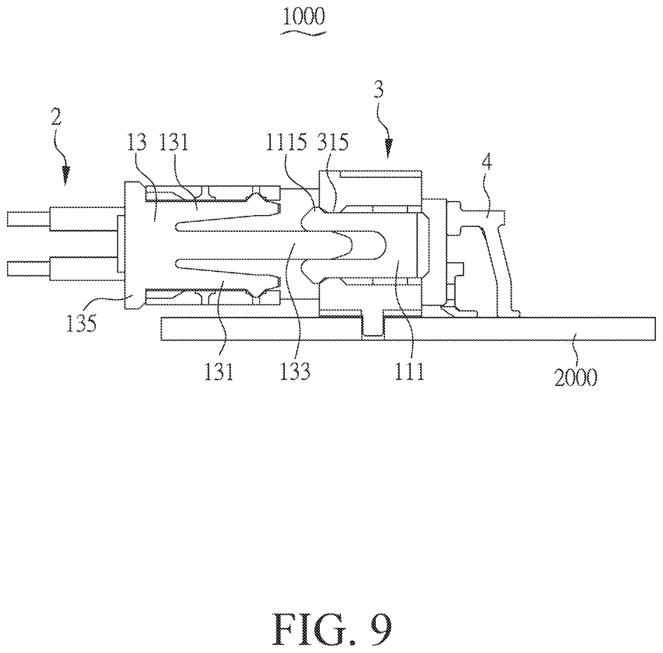

In addition, the connector assembly 1000 of the present invention can also have the effect that erroneous operation of the connector assembly is prevented. Reference is made to FIG. 9. If the user fails to operate the connector assembly in a manner as mentioned above or if the locking member 13 is moved to the insertion position by pressing the operating part 135 with the extension part 133 being inserted into the insertion space 1113 between the pair of first elastic arms 1111 prior to engagement of the wire-end connector with the board-end connector, then the first protruding parts 1115 will be stopped by the second protruding parts 315. The flexible positioning member 111 cannot be disposed in the side connection region S1 due to the fact that there is insufficient space for allowing elastic deformation of the first elastic arms 1111.

To conclude, the connector assembly of the present invention can ensure that the board-end connector and the wire-end connector can be certainly locked after being engaged with each other, so as to improve the reliability and stability of the connection between the board-end connector and the wire-end connector. In addition, the locking structure of the present invention also has a foolproof design for enabling the user to engage the connectors with each other and then lock the connectors in a correct manner.

The above embodiments are used only to illustrate the implementations of the present invention and to explain the technical features of the present invention, and are not used to limit the scope of the present invention. Any modifications or equivalent arrangements that can be easily accomplished by people skilled in the art are considered to fall within the scope of the present invention, and the scope of the present invention should be limited by the claims of the patent application.

What is claimed is:

1. A lockable connector assembly, comprising:
a wire-end connector, comprising a first body and a locking member, the first body having a flexible positioning member and a side guide groove, the locking member being movably disposed in the side guide groove and being movable between an initial position where the locking member is distal from the flexible positioning member and an insertion position where the locking member is abutted against the flexible positioning member;
a plurality of wires, one end of each wire being disposed in the first body;
a board-end connector, comprising a second body, the second body having an accommodating space for reception of the first body; and
a plurality of contacts, being partially extended and disposed in the second body;
wherein when the locking member is in the initial position, the wire-end connector is capable of being engaged with the board-end connector so that the first body is partially disposed in the accommodating space and that the flexible positioning member is located in a locked position of the accommodating space, and the contacts are electrically connected to the wires, and wherein when the locking member is moved from the initial position to the insertion position, the locking member is abutted against the flexible positioning member so that the flexible positioning member is retained in the locked position.

2. The lockable connector assembly of claim 1, wherein the flexible positioning member has a pair of first elastic arms, an insertion space is formed between the pair of first elastic arms, the locking member has an extension part, and when the locking member is moved to the insertion position, the extension part is inserted into the insertion space to restrict the pair of first elastic arms.

3. The lockable connector assembly of claim 2, wherein the accommodating space comprises a side connection region for accommodating the flexible positioning member, each of the pair of first elastic arms has a first protruding part, the second body has two second protruding parts formed on the side connection region and facing each other, a gap between the second protruding parts is smaller than outer dimension defined by the first protruding parts of the pair of first elastic arms under a normal condition, and when the wire-end connector is engaged with the board-end connector, the first protruding parts and the second protruding parts interfere with each other so that the pair of first elastic arms are deformed.

4. The lockable connector assembly of claim 3, wherein the locking member further has a pair of second elastic arms, the pair of second elastic arms and the extension part are disposed in the side guide groove, and the extension part is located between the pair of second elastic arms.

5. The lockable connector assembly of claim 4, wherein when the wire-end connector is engaged with the board-end connector and the locking member is located in the insertion position, the extension part partially extends to the side connection region and is inserted into the plugging space.

6. The lockable connector assembly of claim 4, wherein the locking member further has a pair of positioning bumps respectively formed on the pair of second elastic arms, and the wire-end connector further has a first positioning hole and a second positioning hole formed in the side guide groove, and the positioning bump is engaged with the first positioning hole when the locking member is located in the initial position, and the positioning bump is engaged with the second positioning hole when the locking member is located in the insertion position.

7. The lockable connector assembly of claim 6, wherein the wire-end connector further has a stop part adjacent to the first positioning hole.

8. The lockable connector assembly of claim 4, wherein the locking member further has an operating part outside the side guide groove.

9. The lockable connector assembly of claim 4, wherein the board-end connector is disposed on a circuit board, one end of each contact is electrically connected to the circuit board, and the other end of each contact extends into the accommodating space of the second body.

10. The lockable connector assembly of claim 4, wherein the wire-end connector further includes a locking structure for retaining the wires.

11. The lockable connector assembly of claim 4, wherein when the locking member is located in the insertion position first, and the flexible positioning member is prevented from entering the side connection region by interference between the first protruding parts and the second protruding parts.
